(19) United States
(12) Patent Application Publication
(10) Pub. No.: US 2012/0243452 A1
(43) Pub. Date: Sep. 27, 2012

(54) MPDU STRUCTURE AND RELATED METHODS FOR USE IN A WIRELESS COMMUNICATIONS PROTOCOL

(76) Inventors: Joey Chou, Scottsdale, AZ (US); Muthaiah Venkatachalam, Beaverton, OR (US); Aran Bergman, Givatayim (IL)

(21) Appl. No.: 13/071,878

(22) Filed: Mar. 25, 2011

(51) Int. Cl. H04W 80/00

(52) U.S. Cl. 370/310

(57) ABSTRACT

An MPDU structure for use in a wireless communications protocol includes a basic header (310) including an extended header bit (312) and ending with a length field (313) and further includes an extended header group (330) that begins with a length extension field (331) and that further includes an extended header flag bit (332). The MPDU structure may also include a payload (320).

### FIELD OF THE INVENTION

The disclosed embodiments of the invention relate generally to wireless communications, and relate more particularly to efficient wireless data transfer.

### BACKGROUND OF THE INVENTION

Wireless systems and networks enable over-the-air information transfer between transmitter and receiver. As an example, the IEEE 802.16 standard (with its various versions and updates) defines a wireless broadband protocol for a wireless metropolitan area network (WirelessMAN). This particular standard is also known by the name Worldwide Interoperability for Microwave Access, or WiMAX.

WiMAX networks, in common with other communications systems, rely upon a Media Access Control (MAC) sublayer to provide addressing and multiple access control mechanisms among wireless user equipment in a point to multi-point network. MAC protocol data units (PDUs) are a package of data (i.e., a group of data bits) that contain header, connection address, and data protocol information that is used to control and transfer information across a medium (such as a radio channel). MAC PDUs in WiMAX systems contain a header that holds connection identifier and control information, and may also contain a payload of data after the header.

The MAC header in the 802.16m standard has an 11-bit length field that limits the size of the MAC PDU (MPDU) to 2047 bytes. The limited size of the MPDU makes the support of functions such as fragmentation, packing, multiplexing, and the like impractical. For example, consider a version of the 802.16 standard in which the maximum size of a burst is defined as 14,350 bytes. This means that as many as eight MPDUs may be needed to accommodate a burst, and this increases the header overhead considerably.

FIG. 1 illustrates a prior art MPDU structure 100 that includes an Advanced Generic MAC Header (AGMH) 110 and a payload 120. Payload 120 is illustrated using a byte 126 and a byte 128—separated by a space suggesting that additional (non-illustrated) bytes may also be present—but these two bytes should be taken as being representative of payloads of any size (up to 2045 bytes)—including payloads of two bytes, payloads of a single byte, or no payload at all (zero bytes).

AGMH 110 is made up of two bytes: a byte 116 and a byte 118, arranged as follows: a 4-bit FlowID 111, a 1-bit EH field 112, and an 11-bit length field (LEN0-LEN10) 113. MPDU structure 100 as illustrated in FIG. 1 has EH bit 112 set to 0 which, for the protocol being shown, means no extended header is present. FIG. 2 illustrates MPDU structure 100 with EH bit 112 set to 1, which, as shown, and as further discussed below, means that an extended header 210 is present. Extended header 210, like AGMH 110, comprises two bytes: a byte 216 and a byte 218. Byte 216 comprises an 8-bit EH Length field 211. Byte 218 comprises a 4-bit type field 212 and a body that varies in length according to its type. It should be noted that EH Length field 211 indicates a length of extended header 210 only (and not a length of MPDU 100, for example).

Note that length field 113 is made up of three bits from byte 116 and eight bits from (i.e., all of) byte 118. If all 11 bits in length field 113 are set to 1 the corresponding size indication for MPDU 100 is 2047 bytes. This relatively small size often leads to inefficiencies. For example, as mentioned above, a large burst requires multiple MPDUs, each of which has its own header. Among other things, this represents a waste of resources and requires increased processing power.

The need to support MPDU sizes larger than 2047 bytes has not gone unrecognized. In the prior art protocol of FIGS. 1 and 2, such MPDU length extension is handled by adding an MPDU Length Extended Header (MLEH) to MPDU structure 100. (Other extended header types may also be present but the MLEH, when present, is added as the first extended header in this prior art protocol.) In FIG. 2, extended header 210 takes the form of an MLEH, which, in addition to the 4-bit type field 212, has a 3-bit body forming an EH data field 213 and a final (reserved) bit 214 that is set to zero. Thus, in the prior art protocol of FIGS. 1 and 2, when MPDU length is greater than 2047 bytes, type field 212 will be set to indicate a length extended header type (an MLEH) and the bits within EH data field 213 will be chosen such that they, together with length field 113 of AGMH 110, indicate the desired MPDU size. However, because the two MPDU length fields (i.e., length field 113 and EH data field 213) are not contiguous—i.e., they are separated by EH Length field 211 and type field 212—significant calculation is required before MPDU length can be determined. For example, when a receiver receives an MPDU the receiver does not know the size of the MPDU until it (the receiver) parses all extended headers in order to determine whether an extended header is present. Such parsing and length calculations add significant overhead to the MPDU processing. In fact, the additional processing burden may be even more onerous than what is apparent from the preceding sentences because in addition to what has been said, additional processing power must be used to decode the type bits prior to calculating the MPDU length. In cases where there is data encryption the data must be decrypted—but without knowing the size such decryption is rather an involved process. In short, MPDU length extension support in the FIGS. 1 and 2 protocol is often very inefficient.

### BRIEF DESCRIPTION OF THE DRAWINGS

The disclosed embodiments will be better understood from a reading of the following detailed description, taken in conjunction with the accompanying figures in the drawings in which:

FIGS. 1 and 2 are schematic representations of an MPDU 100 according to an existing wireless communication protocol;

FIGS. 3 and 4 are schematic representations of an MPDU structure for use in a wireless communications protocol according to various embodiments of the invention; and

FIGS. 5 and 6 are flowcharts illustrating methods of supporting an MPDU in a wireless communications protocol according to embodiments of the invention.

For simplicity and clarity of illustration, the drawing figures illustrate the general manner of construction, and descriptions and details of well-known features and techniques may be omitted to avoid unnecessarily obscuring the discussion of the described embodiments of the invention. Additionally, elements in the drawing figures are not necessarily drawn to scale. For example, the dimensions of some of the elements in the figures may be exaggerated relative to other elements to help improve understanding of embodiments of the present invention. Certain figures may be shown in an idealized fashion in order to aid understanding, such as when structures are shown having straight lines, sharp angles, and/or parallel planes or the like that under real-world conditions would likely be significantly less symmetric and orderly. The same reference numerals in different figures denote the same elements, while similar reference numerals may, but do not necessarily, denote similar elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method. Furthermore, the terms “comprise,” “include,” “have,” and any variations thereof, are intended to cover a non-exclusive inclusion, such that a process, method, article, or apparatus that comprises a list of elements is not necessarily limited to those elements, but may include other elements not expressly listed or inherent to such process, method, article, or apparatus.

The terms “left,” “right,” “front,” “back,” “top,” “bottom,” “over,” “under,” and the like in the description and in the claims, if any, are used for descriptive purposes and not necessarily for describing permanent relative positions unless otherwise indicated either specifically or by context. It is to be understood that the terms so used are interchangeable under appropriate circumstances such that the embodiments of the invention described herein are, for example, capable of operation in other orientations than those illustrated or otherwise described herein. The term “coupled,” as used herein, is defined as directly or indirectly connected in an electrical or non-electrical manner. Objects described herein as being “adjacent to” each other may be in physical contact with each other, in close proximity to each other, or in the same general region or area as each other, as appropriate for the context in which the phrase is used. Occurrences of the phrase “in one embodiment” herein do not necessarily all refer to the same embodiment.

The following description makes reference to a base station (BS) and a mobile station (MS). In the downstream or downlink case, it should be understood that, where applicable, the BS may alternatively be referred to as enhanced Node B (eNB) or access point (AP) at the system level herein, and that (in this downlink case) the MS may alternatively be referred to as a subscriber station (SS) or user equipment (UE) or station (STA) at the system level herein. Further, the terms BS, eNB, and AP may be conceptually interchanged, depending on which wireless protocol is being used, so a reference to BS herein may also be seen as a reference to either of eNB or AP. Similarly, a reference to MS or SS herein may also be seen as a reference to either of UE or STA.

### DETAILED DESCRIPTION OF THE DRAWINGS

In one embodiment of the invention, an MPDU structure for use in a wireless communications protocol comprises a basic header comprising an extended header bit and ending with a length field and further comprises an extended header group that begins with a length extension field and also comprises an extended header flag bit. The MPDU structure may also include a payload.

Embodiments of the invention enable a method to increase the MPDU size to 14,350 bytes (i.e., the maximum size of a burst) without changing the format of the AGMH. (Some embodiments of the invention set an upper limit of 14,350 bytes on MPDU size, in order to match the largest possible burst sizes.) Furthermore, while extended headers are still an option with embodiments of the invention, they are no longer required to support MPDU length extensions. As further described below, embodiments of the invention place length extension bits of a newly-defined extended header group (EHG) so as to be contiguous with the length bits of the AGMH, thus leading to efficiencies in terms of size—a one byte is saved—and also in terms of processing. System overhead can be greatly reduced with the removal of a requirement to parse through other information before getting to the extended header information.

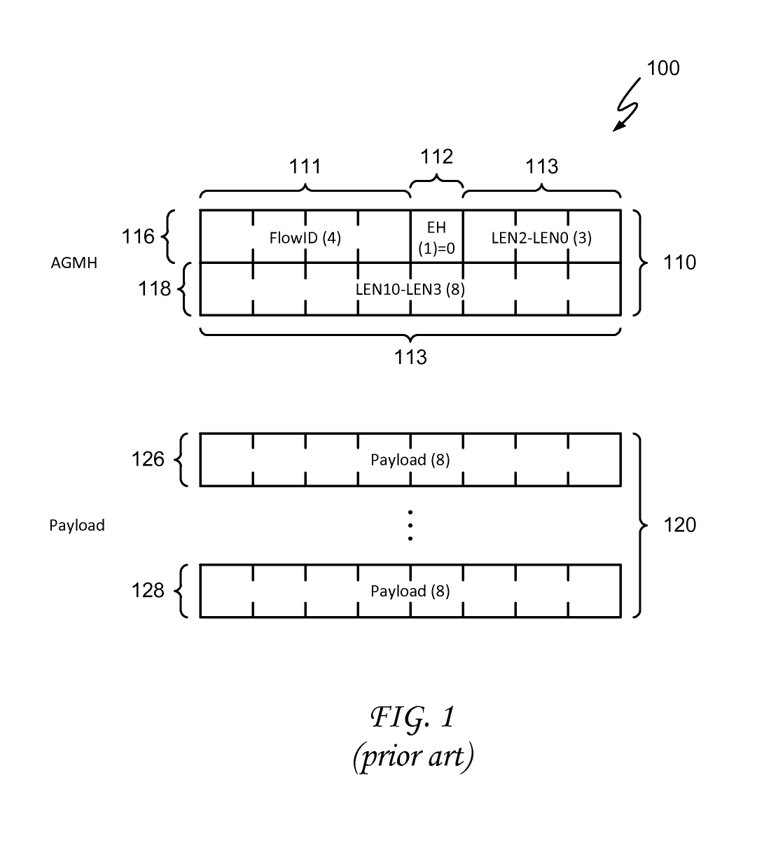

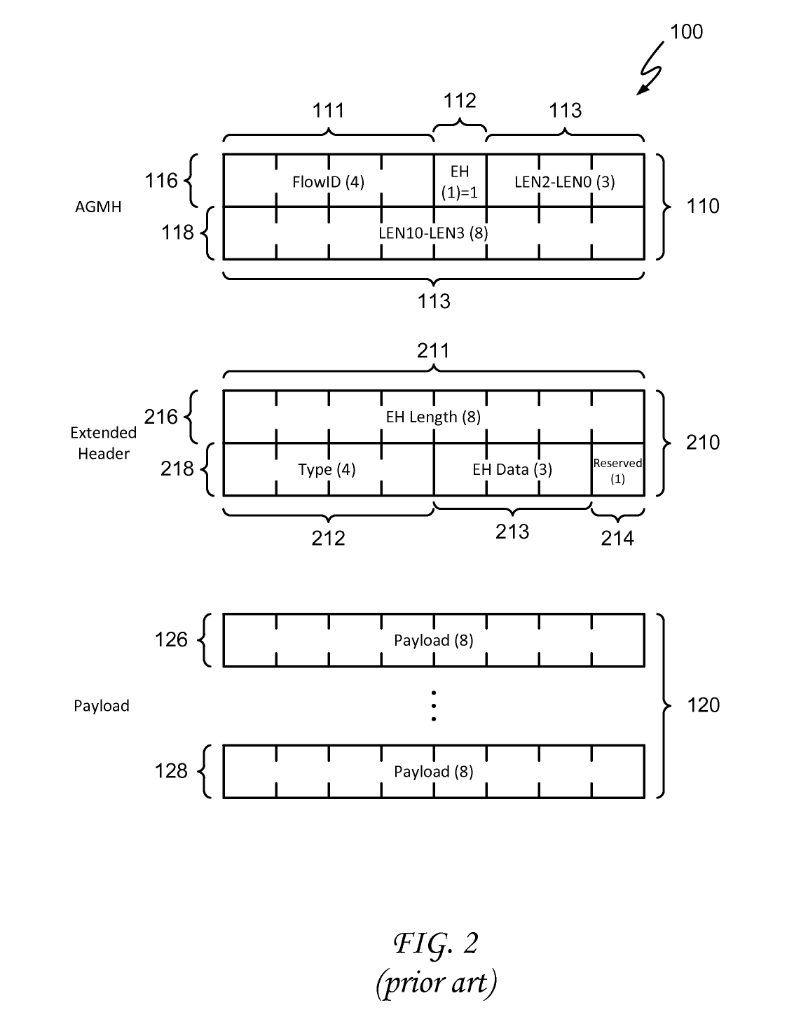

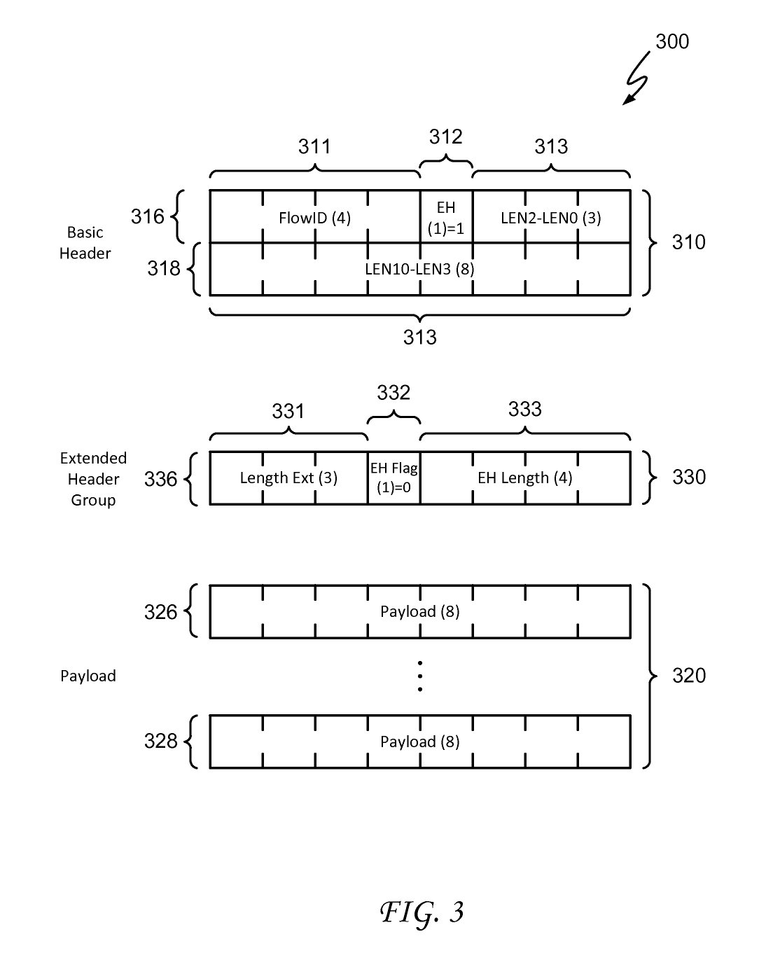

Referring again to the drawings, FIG. 3 is a schematic representation of an MPDU structure 300 for use in a wireless communications protocol according to an embodiment of the invention. Electronic devices capable of communicating over wireless communications networks that make use of MPDU structure 300 include, for example, hand-held computing devices such as cell phones, smart phones, music players, etc. and mobile computing devices such as laptops, nettops, tablets, etc. As illustrated in FIG. 3, MPDU structure 300 comprises a basic header 310 that comprises an extended header bit 312 and ends with a length field 313. It should be noted that basic header 310 has the same format as AGMH 110 shown in FIGS. 1 and 2. Thus, basic header 310 comprises four identification bits 311 (shown in FIG. 3 as a 4-bit FlowID), a 1-bit EH field 312, and an 11-bit length field (LEN0-LEN10) 313. Like AGMH 110, basic header 310 is made up of two bytes: a byte 316 and a byte 318. Length field 313 is made up of three bits from byte 316 and eight bits from (i.e., all of) byte 318.

In the protocol of FIGS. 1 and 2, setting EH bit 112 equal to one indicated the presence of extended header 210. In the FIG. 3 protocol, setting corresponding EH bit 312 equal to one indicates the presence of a new construct: EHG 330. This is followed by a payload 320, illustrated using representative bytes 326 and 328. These two bytes should be thought of as representative of payloads of any size—including zero (i.e., no payload)—up to 16,383 bytes.

As shown, EHG 330, which (in the illustrated embodiment) occupies a single byte 336, begins with a length extension field 331 (e.g., LEN11, LEN12, LEN13) and further comprises an extended header flag bit 332. In the illustrated embodiment, length extension field 331 is composed of three bits, extended header flag bit 332 occupies the next position within byte 336, and a 4-bit data field 333 takes up the final positions. In one embodiment, data field 333 forms at least a first portion of an extended header length field, to be further described below. Other embodiments may assign other functions to the available bits or rearrange the bit order. Even in such other embodiments, however, it is important to maintain the function and location of length extension field 331 as they have been described and shown in order to realize the benefits, addressed above, of having the length extension field be contiguous with length field 313. The 3-bit length extension field (331) is added to the 11-bit length field (313)—for a total of 14 bits—so as to support MPDU sizes up to the defined maximum burst size of 14,350 bytes and, if necessary, beyond that to 16,383 bytes (which is the maximum size that may be represented using 14 bits).

It should be noted that in some scenarios an MPDU of 2047 bytes or smaller is sufficient such that no MPDU length extension is needed. For example, perhaps no features such as fragmentation, packing, battery power, or the like need to be indicated. In such scenarios, the three bits of length extension field 331 may be set to zero (indicating no length extension) and the length of MPDU structure 300 may be indicated using only the eleven bits of length field 313.

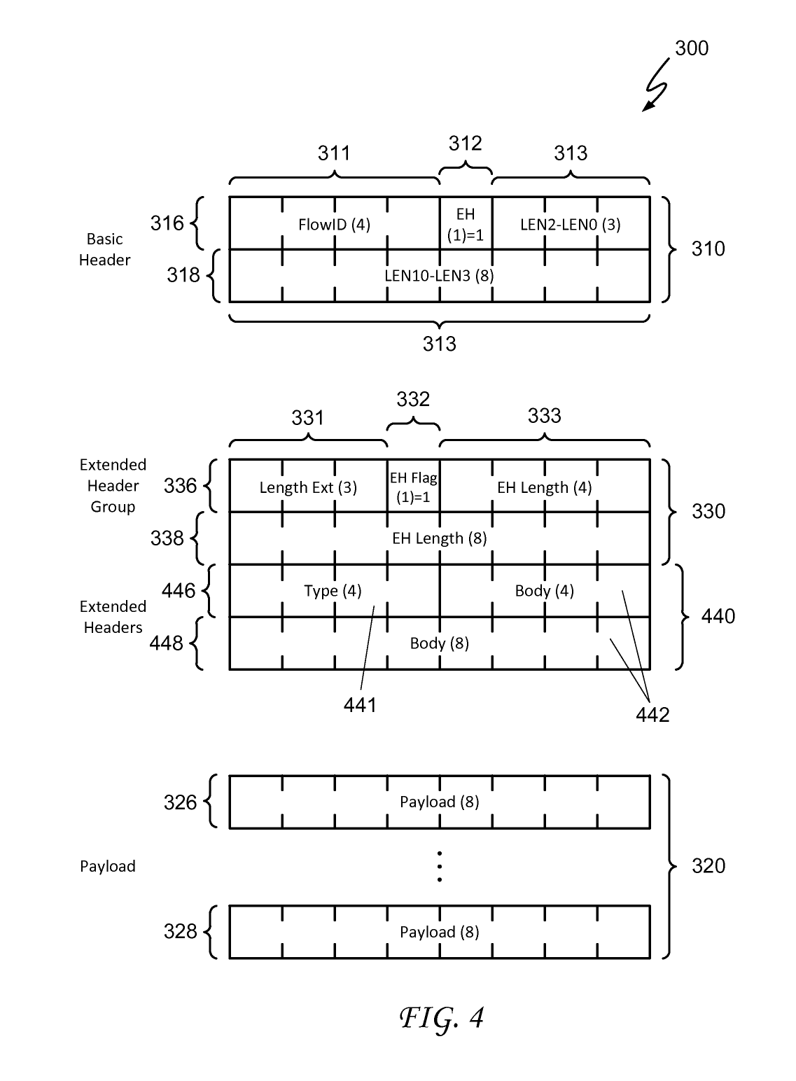

EH flag bit 332 can be set either to one or to zero, indicating the presence or absence, respectively, of an 8-bit EH Length field 338 (see FIG. 4). Because EH flag bit 332 is set to zero in FIG. 3, EH Length field 338 is not present, and EHG 330 is made up only of byte 336. In that scenario, data field 333, described above as forming at least a first portion of an extended header length field, represents the entire extended header length field, no other portion being present. The four bits of data field 333 may be arranged so as to indicate extended headers of lengths ranging from zero bytes (no extended header) to 15 bytes.

FIG. 4 illustrates an embodiment of MPDU structure 300 in which EH flag bit 332 is set to one and where, accordingly, EH Length field 338 is present. Turning then to FIG. 4, it may be seen that EHG 330 (with the EH flag bit=1) further comprises 8-bit EH Length field 338. This field, when present, forms a second portion of the extended header length field introduced above. Thus, in various embodiments, MPDU structure 300 can have an EH Length field made up either of four bits (the four bits of data field 333) or of 12 bits (the four bits just mentioned plus the additional 8 bits of EH Length field 338). The reason for this is that in some cases four bits is sufficient for the required size indication. As mentioned above, four bits can indicate sizes up to 15 bytes so for sizes not exceeding that number EH Length field 338 may be omitted (by setting EH Flag bit=0), thus saving one byte (the byte that EH Length field 338 would otherwise have occupied). And indeed, in some cases the extended headers are small and there is no need to use the extra byte. In other cases the extended headers are longer than 15 bytes and in those cases the extra byte of length field would need to be included (so as to indicate extended headers having lengths up to 4095 bytes).

Referring still to FIG. 4, MPDU structure 300 further comprises one or more extended headers 440, each of which comprises a type field followed by a body. A single extended header is illustrated in FIG. 4 by bytes 446 and 448 which, following a pattern established in earlier figures, should be taken as representative of any number of extended headers having a combined size of up to 4096 bytes (as may be indicated by a 12-bit length field). In the illustrated embodiment, these extended headers take the form of a 4-bit type field 441 within byte 446 and a body 442 made up of the remaining four bits of byte 446 plus the eight bits of byte 448. In other embodiments, extended headers may have 4-bit type fields and bodies having some other number of bits—as determined by the type—with the condition that an extended header has to end on a byte boundary.

The length of body 442 for a particular instance is determined by type field 441. The information that may be conveyed in an extended header includes information having to do with features such as fragmentation, battery power, packing, multiplexing, and many others. Thus, to take one example, a mobile station within a wireless network may report to a base station regarding its remaining battery power by setting the type field in an MPDU to indicate battery power (this indication can be made using just a number, for example) and by setting the body to an appropriate indication of battery power status. And each extended header type has a data size associated with it, so that based on the type the size of the data may be determined. Where multiple extended headers are present, as when additional information beyond battery power is to be reported, for example, the sizes of each extended header can be added together and the total size indicated by length field 333 and, if EH flag bit 332=1, also by EH Length field 338.

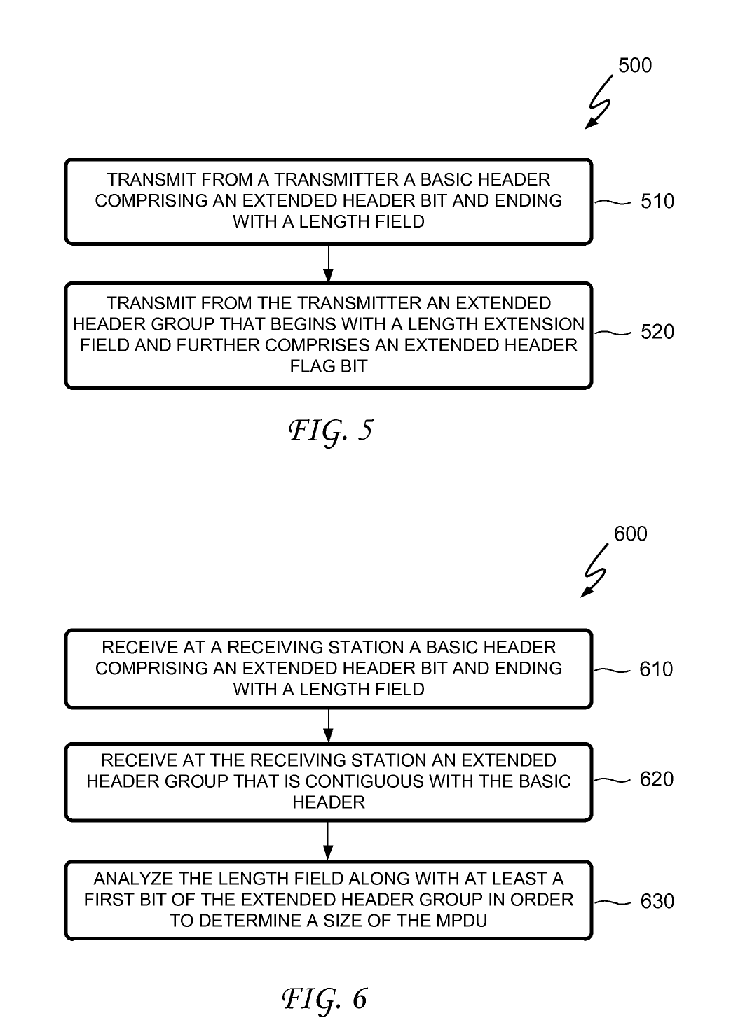

FIG. 5 is a flowchart illustrating a method 500 of supporting an MPDU in a wireless communications protocol according to an embodiment of the invention. As an example, the MPDU can have a structure, including a MAC header format, like that shown in FIG. 3 or 4.

A step 510 of method 500 is to transmit from a transmitter a basic header comprising an extended header bit and ending with a length field. In one embodiment, step 510 or another step of method 500—or a preliminary step to method 500 or another method—is to define a maximum size of the MPDU as being 14,350 bytes. Advantages of or reasons for doing so have been discussed above.

As an example, the transmitter can be a base station or a mobile station in a WiMAX network. That is, WiMAX base stations and WiMAX mobile stations both sometimes transmit information. (Both sometimes receive information as well.) When a base station or a mobile station is transmitting information then it is, of course, acting as a transmitter.

As another example, the basic header can be similar to basic header 310 and its components that were described above in connection with FIGS. 3 and 4. Accordingly, in one embodiment the basic header comprises a first byte made up of four identification bits, the extended header bit, and three length bits that form a first portion of the length field, and the basic header further comprises a second byte made up of eight length bits that form a second portion of the length field.

A step 520 of method 500 is to transmit from the transmitter an extended header group that begins with a length extension field and further comprises an extended header flag bit. As an example, the extended header group can be similar to EHG 330 and its components that were described above in connection with FIGS. 3 and 4. Accordingly, in one embodiment the extended header group includes an initial byte comprising three bits that form the length extension field, the extended header flag bit, and four bits that form at least a first portion of an extended header length field. The extended header group may further comprise a second byte made up of eight bits that make up a second portion of the extended header length field.

When the extended header flag bit is equal to 1 then, in one embodiment, the MPDU further comprises an extended header, which, as an example, can be similar to extended headers 440 and their components that were described above in connection with FIG. 4. Accordingly, the extended header may comprise a type field and a body, wherein the type field is made up of four bits that indicate a type and wherein the body has a length determined by the type.

FIG. 6 is a flowchart illustrating a method 600 of supporting an MPDU in a wireless communications protocol according to an embodiment of the invention. As an example, the MPDU can have a structure, including a MAC header format, like that shown in FIG. 3 or 4. Electronic devices capable of use within wireless communications protocols that support an MPDU structure according to at least one of method 500 and method 600 include, for example, hand-held computing devices such as cell phones, smart phones, music players, etc. and mobile computing devices such as laptops, nettops, tablets, etc.

A step 610 of method 600 is to receive at a receiving station a basic header comprising an extended header bit and ending with a length field. In one embodiment, step 610 or another step of method 600—or a preliminary step to method 600 or another method—is to define a maximum size of the MPDU as being 14,350 bytes. Advantages of or reasons for doing so have been discussed above.

As an example, the receiver can be a base station or a mobile station in a WiMAX network. That is, as first mentioned above, WiMAX base stations and WiMAX mobile stations both sometimes receive information, just as they both sometimes transmit information. When a base station or a mobile station is receiving information then it is, of course, acting as a receiver.

As another example, the basic header can be similar to basic header 310 and its components that were described above in connection with FIGS. 3 and 4. Accordingly, in one embodiment the basic header comprises a first byte made up of four identification bits, the extended header bit, and three length bits that form a first portion of the length field, and the basic header further comprises a second byte made up of eight length bits that form a second portion of the length field.

A step 620 of method 600 is to receive at the receiving station an extended header group that is contiguous with the basic header.

A step 630 of method 600 is to analyze the length field along with at least a first bit of the extended header group in order to determine a size of the MPDU. In one embodiment, the extended header group begins with a length extension field and further comprises an extended header flag bit, and step 630 of method 600 may comprise analyzing all of the bits of the length extension field. Previously, before the development of the invention of which embodiments are described herein, the length field in the basic header (e.g., the AGHM) did not convey information about MPDU size and thus it was not possible to determine MPDU size by performing an analysis of the length field along with at least a first bit of the extended header group (which in previous protocols did not exist). Rather, as has been described elsewhere herein, MPDU length determinations made in such previous protocols required resource-intensive processing even just to identify the location of MPDU length information.

As an example, the extended header group can be similar to EHG 330 and its components that were described above in connection with FIGS. 3 and 4. Accordingly, in one embodiment step 630 comprises receiving an extended header group including an initial byte that comprises three initial bits that form the length extension field followed by the extended header flag bit and followed next by four bits that form at least a first portion of an extended header length field. Here, it would be these three bits of the length extension field that would be analyzed in step 630 in order to determine a size of the MPDU. Step 630 may further comprise receiving a second byte made up of eight bits that make up a second portion of the extended header length field.

When the extended header flag bit is equal to 1 then, in one embodiment, the MPDU further comprises an extended header, which, as an example, can be similar to extended headers 440 and their components that were described above in connection with FIG. 4. Accordingly, the extended header may comprise a type field and a body, wherein the type field is made up of four bits that indicate a type and wherein the body has a length determined by the type.

Although the invention has been described with reference to specific embodiments, it will be understood by those skilled in the art that various changes may be made without departing from the spirit or scope of the invention. Accordingly, the disclosure of embodiments of the invention is intended to be illustrative of the scope of the invention and is not intended to be limiting. It is intended that the scope of the invention shall be limited only to the extent required by the appended claims. For example, to one of ordinary skill in the art, it will be readily apparent that the MPDU and the related structures and methods discussed herein may be implemented in a variety of embodiments, and that the foregoing discussion of certain of these embodiments does not necessarily represent a complete description of all possible embodiments.

Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. An MPDU structure for use in a wireless communications protocol, the MPDU structure comprising:
a basic header comprising an extended header bit and ending with a length field; and
an extended header group beginning with a length extension field and further comprising an extended header flag bit.

2. The MPDU structure of claim 1 wherein:
the basic header comprises:
a first byte made up of four identification bits, the extended header bit, and three length bits that form a first portion of the length field; and
a second byte made up of eight length bits that form a second portion of the length field.

3. The MPDU structure of claim 2 wherein:
the extended header group includes an initial byte comprising:
three bits that form the length extension field;
the extended header flag bit; and
four bits that form at least a first portion of an extended header length field.

4. The MPDU structure of claim 3 wherein:
the extended header group further comprises a second byte made up of eight bits that make up a second portion of the extended header length field.

5. The MPDU structure of claim 4 further comprising:
an extended header.

6. The MPDU structure of claim 5 wherein:
the extended header comprises a type field and a body.

7. The MPDU structure of claim 6 wherein:
the type field is made up of four bits that indicate a type; and
the body has a length determined by the type.

8. The MPDU structure of claim 1 wherein:
a maximum size of the MPDU is 14,350 bytes.

9. An electronic device capable of communicating over a wireless communications network that makes use of the MPDU structure of claim 1.

10. A method of supporting an MPDU in a wireless communications protocol, the method comprising:
transmitting from a transmitter a basic header, the basic header comprising an extended header bit and ending with a length field; and
transmitting from the transmitter an extended header group that begins with a length extension field and further comprises an extended header flag bit.

11. The method of claim 10 wherein:
the basic header comprises:
a first byte made up of four identification bits, the extended header bit, and three length bits that form a first portion of the length field; and
a second byte made up of eight length bits that form a second portion of the length field.

12. The method of claim 11 wherein:
the extended header group includes an initial byte comprising:
three bits that form the length extension field;
the extended header flag bit; and
four bits that form at least a first portion of an extended header length field; and
the extended header group further comprises a second byte made up of eight bits that make up a second portion of the extended header length field.

13. The method of claim 12 wherein the MPDU further comprises:
an extended header, wherein the extended header comprises a type field and a body,
wherein:
the type field is made up of four bits that indicate a type; and
the body has a length determined by the type.

14. The method of claim 10 wherein:
a maximum size of the MPDU is 14,350 bytes.

15. An electronic device capable of use within a wireless communications protocol that supports an MPDU structure according to the method of claim 10.

16. A method of supporting an MPDU in a wireless communications protocol, the method comprising:
receiving at a receiving station a basic header comprising an extended header bit and ending with a length field;
receiving at the receiving station an extended header group; and
analyzing the length field along with at least a first bit of the extended header group in order to determine a size of the MPDU.

17. The method of claim 16 wherein:
the extended header group begins with a length extension field and further comprises an extended header flag bit; and
analyzing at least the first bit of the extended header group comprises analyzing all of the bits of the length extension field.

18. The method of claim 17 wherein:
the MPDU has a maximum size of 14,350 bytes; and
receiving the extended header group at the receiving station comprises receiving an initial byte comprising three bits that form the length extension field followed by the extended header flag bit and followed next by four bits that form at least a first portion of an extended header length field.

19. The method of claim 18 wherein:
receiving the extended header group at the receiving station further comprises receiving a second byte made up of eight bits that make up a second portion of the extended header length field.

20. The method of claim 16 wherein:
the basic header comprises:
a first byte made up of four identification bits, the extended header bit, and three length bits that form a first portion of the length field; and
a second byte made up of eight length bits that form a second portion of the length field.

21. The method of claim 16 wherein the MPDU further comprises:
an extended header, wherein the extended header comprises a type field and a body,
wherein:
the type field is made up of four bits that indicate a type; and
the body has a length determined by the type.
